(19) United States
(12) Patent Application Publication
(10) Pub. No.: US 2016/0148536 A1
(43) Pub. Date: May 26, 2016

(54) Tracking Nutritional Information about Consumed Food with a Wearable Device

(71) Applicant: ICON Health & Fitness, Inc., Logan, UT (US)

(72) Inventor: Darren C. Ashby, Richmond, UT (US)

(21) Appl. No.: 14/945,118

(22) Filed: Nov. 18, 2015

Related U.S. Application Data
(60) Provisional application No. 62/085,202, filed on Nov. 26, 2014.
(60) Provisional application No. 62/085,200, filed on Nov. 26, 2014.

(51) Int. Cl. G09B 19/00; G09B 5/02

(52) U.S. Cl. CPC G09B 19/0092; G09B 5/02

(57) ABSTRACT

A wearable device having a camera oriented in a field of view of a user when the wearable device is worn by the user. The camera is in communication with a processor and memory. The memory has programmed instructions executable by the processor to detect food within the field of view, identify a type of food within a user's field of view, and generate a calorie value in the food.

### RELATED APPLICATIONS

This application claims priority to U.S. Patent Application Ser. No. 62/085,202 titled “Tracking Nutritional Information about Consumed Food with a Wearable Device” and filed on 26 Nov. 2014, and U.S. Provisional Patent Application Ser. No. 62/085,200 titled “Tracking Nutritional Information about Consumed Food” and filed on 26 Nov. 2014, which applications are herein incorporated by reference for all that they disclose.

### BACKGROUND

Those trying to lose weight often track the number of calories that they consume during a day. The goal is to consume less calories than calories that are burned through exercise and daily body maintenance. Having a deficit of calories in a day is linked to weight loss. On the other hand, body builders and some athletes desire to gain muscle. Thus, they try to eat more calories than they consume during a day. The excess calories are believed to contribute to muscle gain.

To track the number of calories eaten in a day, a user will often look at labels on food packaging and determine the amount of the food that he or she can eat. If there is no calorie information listed on the food packaging, the user may search the internet or look at publications to determine or estimate the amount of calories in the food that he or she is eating.

One type of system for tracking the amount of calories in a user's food is disclosed in U.S. Pat. No. 8,345,930 issued to Amir Tamrakar, et al. In this reference, a computer-implemented method for estimating a volume of at least one food item on a food plate is disclosed. A first and second plurality of images are received from different positions above a food plate, wherein angular spacing between the positions of the first plurality of images is greater than angular spacing between the positions of the second plurality of images. A first set of poses of each of the first plurality of images is estimated. A second set of poses of each of the second plurality of images is estimated based on at least the first set of poses. A pair of images taken from each of the first and second plurality of images is rectified based on at least the first and second set of poses. A 3D point cloud is reconstructed based on at least the rectified pair of images. At least one surface of the food item above the food plate is estimated based on at least the reconstructed 3D point cloud. The volume of the food item is estimated based on the surface. Another type of systems is described in U.S. Patent Publication Nos. 2013/0085345 issued to Kevin A. Geisner, et al and 2012/0096405 issued to Dongkyu Seo. Each of these documents are herein incorporated by reference for all that they contain.

### SUMMARY

In one aspect of the invention, a wearable device includes a camera oriented in a field of view of a user when the wearable device is worn by the user.

In one aspect of the invention, the camera is in communication with a processor and memory.

In one aspect of the invention, the memory comprises programmed instructions executable by the processor to detect food in the field of view.

In one aspect of the invention, the memory comprises programmed instructions executable by the processor to identify a type of food within a user's field of view based at least in part on the image.

In one aspect of the invention, the memory comprises programmed instructions executable by the processor to generate calorie value in the food.

In one aspect of the invention, the programmed instructions are further executable by the processor to determine a volume of the food.

In one aspect of the invention, the processor is in communication with a food library that associates a food type with calories per volume.

In one aspect of the invention, the camera comprises an optical separator to separate wavelengths of light.

In one aspect of the invention, a determination of a food type is based at least in part on at least one optical wavelength characteristic of the image.

In one aspect of the invention, the programmed instructions are further executable by the processor to determine a volume of the food based on different views of the food from different angles.

In one aspect of the invention, the programmed instructions are further executable by the processor to determine whether the user is bringing food towards the user's mouth.

In one aspect of the invention, the programmed instructions are further executable by the processor to cause the camera to automatically capture the image of the food if the user is determined to bring the food towards the user's mouth.

In one aspect of the invention, the programmed instructions are further executable by the processor to communicate the calorie value to the user.

In one aspect of the invention, the programmed instructions are further executable by the processor to notify the user that the calorie value in combination with previously consumed calories exceeds a calorie threshold.

In one aspect of the invention, the programmed instructions are further executable by the processor to determine whether the user consumed the food.

In one aspect of the invention, the programmed instructions are further executable by the processor to send the calorie value to storage if the food is determined to have been consumed by the user.

In one aspect of the invention, a wearable device includes a camera oriented in a field of view of a user when the wearable device is worn by the user.

In one aspect of the invention, the camera is in communication with a processor and memory.

In one aspect of the invention, the memory comprising programmed instructions executable by the processor to determine whether the user is bringing food towards the user's mouth.

In one aspect of the invention, the memory comprising programmed instructions executable by the processor to cause the camera to automatically capture the image of the food if the user is determined to bring the food towards the user's mouth.

In one aspect of the invention, the memory comprising programmed instructions executable by the processor to identify a type of food within a user's field of view based at least in part on the image.

In one aspect of the invention, the memory comprising programmed instructions executable by the processor to determine a volume of the food.

In one aspect of the invention, the memory comprising programmed instructions executable by the processor to determine a calorie value in the food.

In one aspect of the invention, the memory comprising programmed instructions executable by the processor to communicate the calorie value to the user.

In one aspect of the invention, the processor is in communication with a food library that associates a food type with calories per volume.

In one aspect of the invention, the programmed instructions are further executable by the processor to determine a volume of the food based on different views of the food from different angles.

In one aspect of the invention, the programmed instructions are further executable by the processor to notify the user that the calorie value in combination with previously consumed calories exceeds a calorie threshold.

In one aspect of the invention, the programmed instructions are further executable by the processor to determine whether the user consumed the food.

In one aspect of the invention, the programmed instructions are further executable by the processor to send the calorie value to storage if the food is determined to have been consumed by the user.

In one aspect of the invention, the programmed instructions are further executable by the processor to determine a food type base at least in part at least one optical wavelength characteristic of the image.

In one aspect of the invention, a wearable device comprises a camera oriented in a field of view of a user when the wearable device is worn by the user.

In one aspect of the invention, the camera being in communication with a processor and memory.

In one aspect of the invention, the memory comprising programmed instructions executable by the processor to determine whether the user is bringing food towards the user's mouth.

In one aspect of the invention, the memory comprising programmed instructions executable by the processor to cause the camera to automatically capture the image of the food if the user is determined to bring the food towards the user's mouth.

In one aspect of the invention, the memory comprising programmed instructions executable by the processor to identify a type of food within a user's field of view based at least in part on the image.

In one aspect of the invention, the memory comprising programmed instructions executable by the processor to determine a volume of the food based on different views of the food from different angles.

In one aspect of the invention, the memory comprising programmed instructions executable by the processor to determine a calorie value in the food.

In one aspect of the invention, the memory comprising programmed instructions executable by the processor to communicate the calorie value to the user.

In one aspect of the invention, the memory comprising programmed instructions executable by the processor to determine whether the user consumed the food.

In one aspect of the invention, the memory comprising programmed instructions executable by the processor to send the calorie value to storage if the food is determined to have been consumed by the user.

In one aspect of the invention, the processor is in communication with a food library that associates a food type with calories per volume.

Any of the aspects of the invention detailed above may be combined with any other aspect of the invention detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a perspective view of an example of a system for tracking a consumed amount of calories in accordance with the present disclosure.

FIG. 2 illustrates a perspective view of an example of an image of food taken with a camera in accordance with the present disclosure.

FIG. 3 illustrates a block diagram of an example of a food library in accordance with the present disclosure.

FIG. 4 illustrates a block diagram of an example of a mobile device in communication with sensors for tracking an amount of calories consumed in accordance with the present disclosure.

FIG. 5 illustrates a perspective view of an example of a system for tracking a consumed amount of calories in accordance with the present disclosure.

Throughout the drawings, identical reference numbers designate similar, but not necessarily identical, elements.

### DETAILED DESCRIPTION

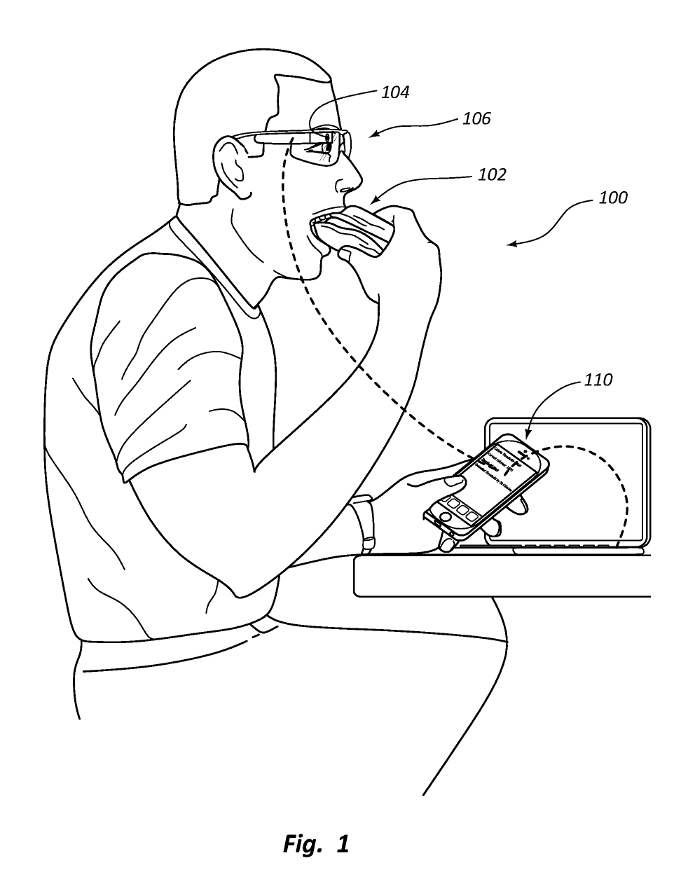

Particularly, with reference to the figures, FIG. 1 illustrates a perspective view of an example of a tracking system 100 for tracking a consumed amount of calories. In this example, a user is consuming an amount of calories by eating food 102. As the user eats, a camera 104 attached to the user's eye wear 106 captures at least one image of the food 102 being brought towards the user's mouth. Based on the images, the food type and food volume may be determined, which can be used to determine the number of calories contained in the food being brought to the user's mouth.

The camera 104 may be positioned at any appropriate location. For example, the camera 104 may be worn by the user on his or her eye wear 106, a hat, a scarf, jewelry, a necklace, a wearable device, a shirt, a coat, another article of clothing, an adhesive, teeth braces, another mechanism or combinations thereof.

The food type and food volume determination may be achieved with a single image. In other examples, multiple images of the food are used. The different images may reveal different characteristics about the food. For example, images of the food from different angles may reveal dimensions of the food that are obscured from other angles. Likewise, different food types may be obscured from different angles as well. The camera 104 may take multiple images of the food as the food approaches the user's mouth. By taking multiple images of the food with the same camera 104 at different distances from the user's mouth, images of the food from slightly different angles may be captured. In some examples, multiples cameras are utilized to capture different angles of the food.

The camera 104 may have a processor and logic to interpret the volume and food types. In other situations, the camera 104 may send the images to another device to interpret the data. In some examples, the camera may send at least a portion of the data to a mobile device 110 for processing or to be relayed to another device for processing. In some cases, the data may be modified prior to being sent to a remote device. For example, the camera 104 may compress data, filter data or otherwise modify the data. In other examples, the camera 104 includes minimal logic to reduce the amount of power needed to operate the camera 104. In some examples, a battery may be fixed to the eye wear 106 or other wearable device holding the camera 104. In other examples, the battery is incorporated directly into the camera 104. Further, the camera 104 may be powered by converting movement and/or heat of the user into useable energy capable of being used by the camera 104.

A processor, whether located in the camera 104 or in a remote device, may interpret the data associated with the images. In the example of FIG. 1, the processor is located in the mobile device 110. The processor may be executed by programmed instructions to determine characteristics of the food in the images, such as the different number of food types, the food types or types, the food types by volume, other characteristics or combinations thereof.

Multiple factors may be used to determine the food volume. For example, the distance of the food from the camera may be a factor for determining the food type. To determine the distance, the camera may include a distance camera. Such a distance camera may include technology where signals are reflected back to the camera and the time of flight between sending the signal and receiving the signal back is used to determine the distance. In some cases, the distance signal may be sent at approximately the same time that the camera captures an image. In other examples, the image of the food is captured at the time that the distance signal is received. In some examples, multiple distance signals are sent throughout the time period that the user is bringing food towards the user's mouth. A time stamp may be associated with each of the sent signals and received signals. These time stamps may be correlated with the time stamps associated with the images. Further, in examples where multiple distance signals are sent, the processor may determine the speed at which the food is being brought towards the mouth. In such cases, even if an image's time stamp does not adequately align with a time stamp of a distance signal, the processor may use the food's speed and the distance signal time stamps to estimate the approximate distance of the food at the time the food's image was captured.

Another factor to determine the food volume may be the size of the container carrying the food. For example, if the food is brought to the mouth in a spoon, the processor may compare the size of the food to the size of the spoon. In some examples, the volume of the bowl of the spoon may be known to the processor. In such an example, if the image reveals the entire bowl of the spoon is filled with food, the processor may determine that the food has at least the volume of the spoon's bowl. The processor may calculate the remaining volume based on the dimensions of the food protruding beyond the spoon's rim. Such dimensions may include the height of the food, the width of the food, the profile shape of the food and so forth. The camera may use these dimensions to determine a mathematically defined profile from which the area beneath the profile can be determined. If just a single image of the food exists, the area beneath the mathematically defined profile may be used to estimate the volume of the food. However, since the food occupies a three dimensional space, the processor may use the mathematically defined profiles of the food from images taken at different angles to determine a more accurate three dimensional representation of the food.

Further, the width and length of the eating utensil, such as spoons, forks, sporks, knifes, chop sticks, glasses, cups or other eating utensils, may be used to as a factor to determine the food's dimensions, and therefore the food's volume. For example, if the food has a width that is exactly half of the width of the eating utensil, then the processor can determine that the food's width is half of the eating utensil's width. In those situations where the dimensions of the eating utensil are known or accessible to the processor, the processor can divide the width of the utensil in half to arrive at the food's width. In situations where the dimensions of the eating utensil are not known to the processor, the processor may estimate the utensil's dimensions based on standard utensil sizes, based on the images, by consulting with a library, another mechanism or combinations thereof. In some cases, the eating utensil may have an identifier known or accessible to the processor, and the processor may store or consult a library that associates the dimensions of the eating utensil with the identifier.

In situations where a user is drinking a fluid from a cup with at least a semi-transparent material, the camera may determine the volume of liquid in the cup prior to the user drinking from the cup. The camera 104 may also take another image of the cup to determine the volume of the fluid in the cup after the user drank from the cup. With the before and after volumes of the fluid, the volume of fluid consumed by the user can be determined.

In some examples, the camera 104 may take an image of the food on the user's plate, bowl, cup, basket or other container containing the food from which the user removes portions of the food with the eating utensil for consumption. In such examples, the processor may determine the food volume on the use's plate and then determine the amount of food removed from the plate as the user eats to determine the overall amount of volume by food type consumed.

In some examples, the eating utensil or food container includes a weighing mechanism that can determine the weight of the food. Such a weighing mechanism may include a scale or another type of mechanism to determine the weight of the food. Such a weighing mechanism may be integrated into the eating utensil, the container, or be associated with these items. In some cases, the difference in the weight on the eating utensil before and after placing food into the user's mouth is used to determine the food volume.

While the examples above list specific factors that may be used to determine the food volume, any appropriate type of mechanism and/or factor may be used to determine the food volume. Further, the food volume analysis may be performed for each type of food brought to the user's mouth for consumption. Also, in some examples, the tracking system may include an option for the user to indicate that the food that was placed in the user's mouth should not be included in the total calorie count. Such an option may be useful in those cases where the user removes the food from his or her mouth without swallowing the food (i.e. the user doesn't like the taste of the food).

Also, any appropriate type of factor may be used to determine the food type. In some examples, the image of the food may be matched to a database of food types. If the food characteristics derived from the image has a high enough correlation with the food characteristics included in the library, the processor may make the food type determination based on the information in the library. Such images may be of food from the user's plate, images of the food on the eating utensils and/or images of food held with the user's hands. In some examples, the images of the food in the food library include images of broken down food that more closely resembles how the broken down pieces of food look like on an eating utensil.

In other examples, the user may have an option to input the types of food that he or she will be consuming during the meal. In such an example, the tracking system just has to distinguish between the already identified types of food.

In other examples, the colors of the food may be used to determine the food type. For example, the camera may include an optical separator that is capable of separating the different wavelengths of light captured in the image. These different wavelengths may be used to identify patterns of light that are representative of different types of food. For example, the tracking system 100 may use an optical spectrum analyzer that can break down the colors per pixel or group of pixels into the different colors depicted in the pixels. In some examples, the pixel colors are also used to determine the boundaries of the food to help determine the food's dimensions.

In some examples, the user may instruct the camera 104 to capture images of the food. The user may instruct the camera 104 to take such photos through a mobile device 110, speech commands, an input mechanism incorporated into the camera, another mechanism or combinations thereof. In alternative examples, the tracking system 100 may automatically instruct the camera 104 to take pictures in response to certain conditions. For example, a motion detector may detect that the user is moving his or her hand closer to his or her mouth. In response to such a movement, the tracking system 100 may instruct the camera 104 to capture a series of images. In another example, a proximity sensor may detect that an eating utensil is within an appropriate distance from the user's mouth and send an instruction to the camera 104 to capture the food's image.

In some cases, the tracking system 100 includes at least two different modes. A first mode may be an inactive mode where the camera 104 does not take pictures. In such a mode, the user can move in any manner, say anything, bring eating utensils to his or her face or perform another type of activity that would otherwise trigger an instruction to the camera to take a picture. In such a mode, the user can operate normally without unintentionally activating the camera 104. In a second mode, the tracking system 100 may detect certain conditions which trigger an instruction to the camera to capture an image of the food. Such triggers may include movements, sounds, actions, inputs, smells, proximity detection, other triggers or combinations thereof.

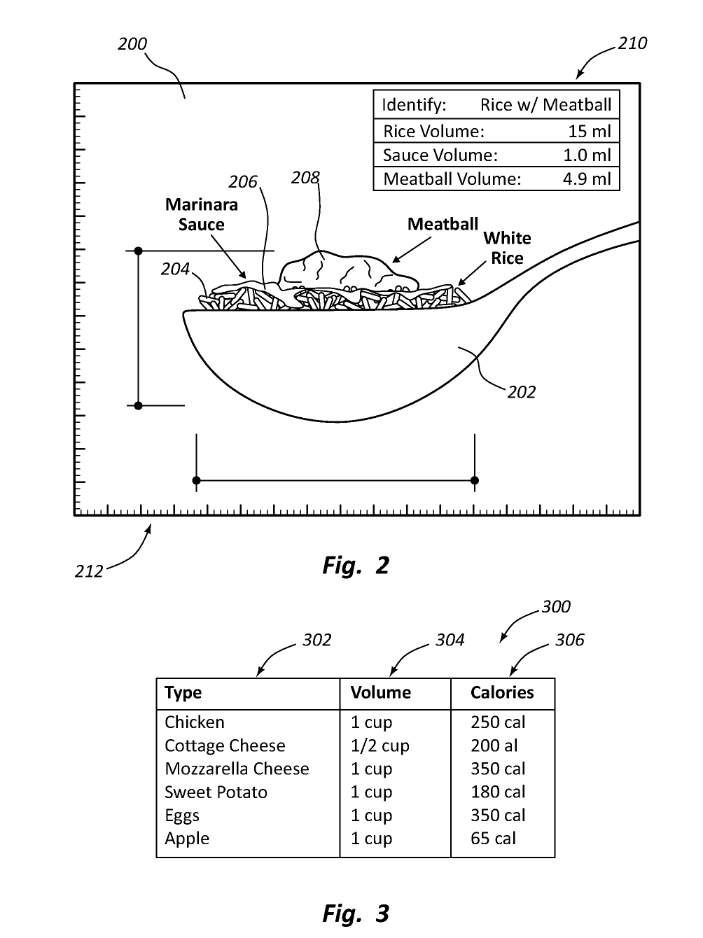

FIG. 2 illustrates a perspective view of an example of an image 200 of food 102 taken with a camera 104 in accordance with the present disclosure. The image 200 is a digital image that can be analyzed and/or modified by the tracking system 100 to identify food types and food volumes. In this example, a spoonful of food 102 is depicted in a spoon 202. The spoon 202 contains multiple types of food, including rice 204, marinara sauce 206 and a meatball 208. Each of these types of food include different volumes and different calorie densities. A chart 210 may be imposed on the image 200 that identifies the food and the amount of calories per food in the spoonful.

In the illustrated example, the image 200 includes a scale 212 that is based on the spoon's distance from the camera 104 when the image was captured. The scale 212 may be used to determine the dimensions of the food 102 by food type.

In some examples, multiple images of the same spoonful of food are analyzed together to improve the accuracy of determining the food's dimensions. For example, a single angle of the food may obscure one of the food's dimension causing the dimension determination from that single angle to be less accurate. However, by analyzing multiple images taken from multiple angles, the accuracy of determining the food's dimensions may increase.

In some examples, the tracking system 100 may operate with assumptions that allow the tracking system 100 to increase its accuracy in determining the food's dimension. For example, the meatball 208 is visible from the top and sides, but the bottom of the meatball is not visible in the image. The tracking system 100 may make an assumption that the bottom of the meatball 208 protrudes into the rice 204 for a short distance. Such a distance may be based on the shape of the meatball's sides and top. Based on such an assumption, the tracking system 100 may increase the determined volume of the meatball 208 based on the protruding distance and accordingly decrease the volume of the rice 204.

Other assumptions may include assumptions about the density of the food. For example, just a portion of the rice 204 is visible with a significant portion of the rice being obscured by the spoon's material. The tracking system 100 may make a determination about the density of the rice based on the spaces between rice grains in the visible portion of the rice. The assumption may include assuming that the rice density of the obscured rice is consistent with the density of the visible rice. While this example has been described with reference to just two specific assumptions, any appropriate assumption may be included in accordance with the principles described in the present disclosure.

FIG. 3 illustrates a block diagram of an example of a food library 300 in accordance with the present disclosure. In this example, the food library 300 includes a first column 302, a second column 304 and a third column 306. The first column 302 describes a food type, and the second column 304 associates a predetermined volume with the food type. The third column associates the number of calories for each food type identified in the first column 302 based on the volume identified in the second column 304. For example, the first row in the first column 302 identifies chicken and the second column 304 identifies a volume of one cup. In the first row of the third column, two hundred fifty calories are identified. Based on the example of FIG. 3, the tracking system 100 is associating two hundred fifty calories with one cup of chicken. As a result, if the tracking system determines that the user has eaten exactly one cup, the tracking system 100 may indicate that the user has eaten two hundred fifty calories. In examples where the user is not eating the volume exactly identified in the library 300, the tracking system 100 may calculate the calorie amount based on the volume listed in the library 300.

While the illustrated example refers to specific types of food, specific types of information, specific calories amounts and specific volume amounts, any appropriate food library 300 may be used in accordance with the principles described in the present disclosure. For example, the food library 300 may assign a different calorie amount for the same food per volume than the calorie amount depicted in FIG. 3. Further, the food library 300 may include more or less food items than depicted in FIG. 3. Likewise, the food library 300 may include different volume amounts. In some examples, the food library 300 includes a different number of columns. In one such example, the second column 304 is removed and the associated calorie amount is based on a consistent volume amount across all of the listed food types.

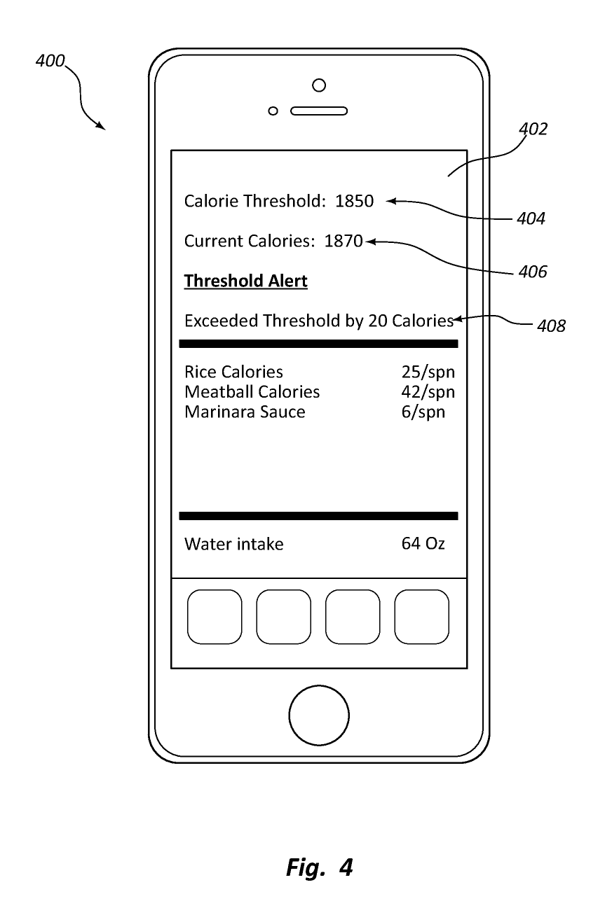

FIG. 4 illustrates a block diagram of an example of a mobile device 400 in communication with sensors for tracking an amount of calories consumed in accordance with the present disclosure. In this example, the mobile device 400 presents information about the tracked calories and/or other food information in a display 402. In the illustrated example, the mobile device 400 is a phone carried by the user. However, any appropriate type of mobile device 400 may be used in accordance with the principles described in the present disclosure. For example, the mobile device 400 may include an electronic tablet, a personal digital device, a laptop, a digital device, another type of device or combinations thereof. Further, while this example is described with reference to a mobile device 400, any appropriate type of device may be used to communicate the status of the user's nutritional goals.

In the illustrated example, the mobile device 400 includes a display 402 that depicts the user's calorie goal 404 and the running total 406 of calories consumed by the user. The user may input his or her goal into the mobile device 400 or another device in communication with the tracking system 100. The user may use any appropriate mechanism for inputting the goal, such as a speech command, a manual command or another type of command. The manual commands may include using buttons, touch screens, levers, sliders, dials, other types of input mechanisms or combinations thereof.

The running total 406 of calories may be determined by the tracking system 100. The tracking system 100 may update the number of calories in response to determining an additional amount of calories is consumed. In some examples, the presentation of the food in the display 402 is delayed from the moment that the user eats his or her food. As a result, the amount of calories consumed in the running total 406 may be updated after the meal has concluded.

The amount of calories are also broken down into the calories from the different food types. As a result, the user may determine how many of his calories came from a particular food source. Knowing the amount of calories from a particular type of food may help the user plan his or her meals, recognize ways to improve his or her nutritional goals, and/or make future adjustments as desired.

Also, in the illustrated example, the amount of water drank by the user is also depicted. The water amount may be determined by applying the principles described above. By identifying the amount of water consumed, the user can determine whether he or she is drinking an appropriate amount of water. In some cases, the user may have a goal to drink a certain amount of water to improve his or her health.

In the illustrated example, the display 402 includes a notification message 408 that the user has exceeded his or her calorie goal by twenty calories. In some examples, the notification message 408 indicates the amount of calories exceeded, while in other examples, the notification message merely indicates that the goal has been exceeded without identifying the specific number of calories. In some cases, the notification message is displayed just in response to the user exceeding his or her goal. In other examples, other notification messages may be displayed prior to the user exceeding the calorie goal. While the above examples of the display have been described with a specific look and feel, any appropriate look and feel may be used to communicate to the user information about his or her food consumption, goals, other information or combinations thereof.

While the illustrated example depicts the amount of water and calories consumed by a user, in some examples other nutritional information is also depicted in the screen. For example, the amount of protein, salt, fruit, vegetables, carbohydrates, other nutritional information or combinations thereof may be depicted to assist the user in making dieting decisions.

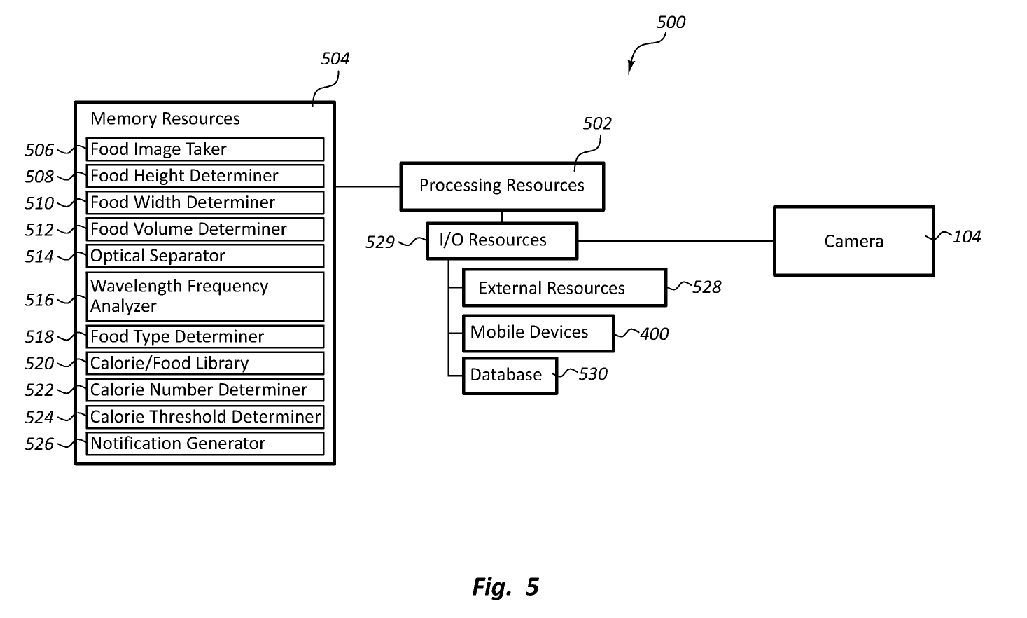

FIG. 5 illustrates a perspective view of an example of a tracking system 100 for tracking a consumed amount of calories in accordance with the present disclosure. The tracking system 100 may include a combination of hardware and programmed instructions for executing the functions of the tracking system 100. In this example, the tracking system 100 includes processing resources 502 that are in communication with memory resources 504. Processing resources 502 include at least one processor and other resources used to process the programmed instructions. The memory resources 504 represent generally any memory capable of storing data such as programmed instructions or data structures used by the tracking system 100. The programmed instructions and data structures shown stored in the memory resources 504 include a food image taker 506, a food height determiner 508, a food width determiner 510, a food volume determiner 512, an optical separator 514, a wavelength frequency analyzer 516, a food type determiner 518, a calorie/food type library 520, a calorie number determiner 522, a calorie threshold determiner 524 and a notification generator 526.

The processing resources 502 may include I/O resources 529 that are capable of being in communication with a remote device that stores the user information, eating history, workout history, external resources 528, databases 530 or combinations thereof. Such a remote device may be a mobile device 400, a cloud based device, a computing device, another type of device or combinations thereof. In some examples, the system communicates with the remote device through a mobile device 400 which relays communications between the tracking system 100 and the remote device. In other examples, the mobile device 400 has access to information about the user. In some cases, the remote device collects information about the user throughout the day, such as tracking calories, exercise, activity level, sleep, other types of information or combination thereof. In one such example, a treadmill used by the user may send information to the remote device indicating how long the user exercised, the number of calories burned by the user, the average heart rate of the user during the workout, other types of information about the workout or combinations thereof.

The remote device may execute a program that can provide useful information to the tracking system 100. An example of a program that may be compatible with the principles described herein includes the iFit program which is available through www.ifit.com and administered through ICON Health and Fitness, Inc. located in Logan, Utah, U.S.A. An example of a program that may be compatible with the principles described in this disclosure are described in U.S. Pat. No. 7,980,996 issued to Paul Hickman. U.S. Pat. No. 7,980,996 is herein incorporated by reference for all that it discloses. In some examples, the user information accessible through the remote device includes the user's age, gender, body composition, height, weight, health conditions, other types of information or combinations thereof.

The processing resources 502, memory resources 504 and remote devices may communicate over any appropriate network and/or protocol through the input/output resources 552. In some examples, the input/output resources 552 includes a transceiver for wired and/or wireless communications. For example, these devices may be capable of communicating using the ZigBee protocol, Z-Wave protocol, BlueTooth protocol, Wi-Fi protocol, Global System for Mobile Communications (GSM) standard, another standard or combinations thereof. In other examples, the user can directly input some information into the tracking system 100 through a digital input/output mechanism, a mechanical input/output mechanism, another type of mechanism or combinations thereof.

The memory resources 504 include a computer readable storage medium that contains computer readable program code to cause tasks to be executed by the processing resources 502. The computer readable storage medium may be a tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, magnetic based memory, other types of memory or combinations thereof.

The food image taker 506 represents programmed instructions that, when executed, cause the processing resources 502 to capture an image of the food. Such a food image taker 506 may receive instructions to capture the image of the food based on speech commands, automatic commands, user input commands, movements of the user, proximity of food to the user's mouth, smells, other triggers or combinations thereof. In some examples, the food image taker 506 causes the camera 104 depicted in the examples described above to capture an image of the food.

In some examples, the food height determiner 508 represents programmed instructions that, when executed, cause the processing resources 502 to determine the height of the food. The food height may be determined based, at least in part, on known dimensions of the eating utensils, the number of pixels dedicated to the food in the images, other factors or combinations thereof. The food width determiner 510 represents programmed instructions that, when executed, cause the processing resources 502 to determine the width of food. The food width may be determined based, at least in part, on known dimensions of the eating utensils, the number of pixels dedicated to the food in the images, other factors or combinations thereof. The food volume determiner 512 represents programmed instructions that, when executed, cause the processing resources 502 to determine the volume of the food. The food volume determination may be based, at least in part, on the outputs of the food height determiner 508 and the food width determiner 510.

The optical separator 514 represents programmed instructions that, when executed, cause the processing resources 502 to separate the wavelengths of light depicted in the images taken with the food image taker 506. The wavelength frequency analyzer 516 represents programmed instructions that, when executed, cause the processing resources 502 to analyze the separated wavelengths to determine the frequency of each type of wavelength.

The food type determiner 518 represents programmed instructions that, when executed, cause the processing resources 502 to determine the type of food in the image. In some examples, the food type is determined by identifying the characteristics of the light wavelengths and matching those optical characteristics with food types with the same or at least similar optical characteristics. In other examples, the food types may be matched with food images or another food identification mechanism may be used.

The calorie/food type library 520 may associate the amount of calories for food with specific food types. Thus, based on the food type determination, the tracking system 100 can look-up the food type in the calorie/food type library 520. The calorie number determiner 222 represents programmed instructions that, when executed, cause the processing resources 502 to determine the calorie amount by multiplying the appropriate calorie to volume measurements included in the calorie/food type library 520 with the volume of the food determined with the food volume determiner 512 described above. Also, the calorie number determiner 522 may add the calories from the different food types consumed by the user to determine the overall amount of calories consumed by the user.

The calorie number determiner 522 may determine a number of calories per bite. In other examples, the calorie number determiner 522 determines a single overall calorie count for an entire meal or time period, such as a day. In some examples, the calorie number determiner 522 maintains a running calorie total for a predetermined time period. In other examples, the calorie number determiner 522 tracks the number of calories consumed by the user for multiple time periods. The calorie number determiner 522 may track calories for a specific meal, a day, a week, another time period or combinations thereof.

The calorie threshold determiner 524 represents programmed instructions that, when executed, cause the processing resources 502 to determine whether a calorie goal has been exceeded. The notification generator 526 represents programmed instructions that, when executed, cause the processing resources 502 to generate a notification to the user about the status of the goal. For example, the notification generator 526 may send a notification in response to the user exceeding his or her calorie goal. In other examples, the notification generator 526 may send a notification to the user indicating that the user is approaching his or her calorie goal. In yet other examples, the notification generator 526 may indicate whether the pace that the user is on will cause the user to exceed or fall short of his or her calorie goal.

The notification generator 526 may send notifications to the user through any appropriate mechanism. For example, the notification generator 526 may cause an email, a text message, another type of written message or combinations thereof to be sent to the user. In other examples, the notification generator 526 may cause an audible message to be spoken to the user. In yet other examples, the notification generator 526 may cause a vibration or another type of haptic event to occur to indicate to the user a notification related to the user's goal.

While the examples above have been described with reference to determining a number of calories being consumed by the user, the principles above may be applied to determining other types of information about the food being consumed by the user. For example, the principles described in the present disclosure may be used to determine the amounts of protein, fat, salt, vitamins, other types constituents or combinations thereof. Such nutritional information may be reported to the user through the same or similar mechanisms used to report the calorie information to the user. Such nutritional information may be ascertained through appropriate libraries that associate the food constituents with the food type per food volume. Further, the user may set goals pertaining to these other nutritional aspects as well. For example, the user may set goals to stay under a certain amount of salt or to consume at least a specific number of grams of protein in a day. The notification generator 230 may notify the user accordingly for such salt intake and protein consumption goals as described above.

Further, the memory resources 504 may be part of an installation package. In response to installing the installation package, the programmed instructions of the memory resources 504 may be downloaded from the installation package's source, such as a portable medium, a server, a remote network location, another location or combinations thereof. Portable memory media that are compatible with the principles described herein include DVDs, CDs, flash memory, portable disks, magnetic disks, optical disks, other forms of portable memory or combinations thereof. In other examples, the program instructions are already installed. Here, the memory resources 504 can include integrated memory such as a hard drive, a solid state hard drive or the like.

In some examples, the processing resources 502 and the memory resources 504 are located within the camera 104, a mobile device, an external device, another type of device or combinations thereof. The memory resources 504 may be part of any of these device's main memory, caches, registers, non-volatile memory or elsewhere in their memory hierarchy. Alternatively, the memory resources 504 may be in communication with the processing resources 502 over a network. Further, data structures, such as libraries or databases containing user and/or workout information, may be accessed from a remote location over a network connection while the programmed instructions are located locally. Thus, the tracking system 100 may be implemented with the camera 104, the mobile device, a phone, an electronic tablet, a wearable computing device, a head mounted device, a server, a collection of servers, a networked device, a watch or combinations thereof. Such an implementation may occur through input/output mechanisms, such as push buttons, touch screen buttons, voice commands, dials, levers, other types of input/output mechanisms or combinations thereof. Any appropriate type of wearable device may include, but are not limited to glasses, arm bands, leg bands, torso bands, head bands, chest straps, wrist watches, belts, earrings, nose rings, other types of rings, necklaces, garment integrated devices, other types of devices or combinations thereof.

The tracking system 100 of FIG. 5 may be part of a general purpose computer. However, in alternative examples, the tracking system 100 is part of an application specific integrated circuit.

While the examples above have been described with reference to a specific camera, it is understood that the camera may be a single camera or a group of cameras capable of taking pictures of the user's food whether the food be in a cup, a plate, another container, on an eating utensil, another mechanism for helping the user eat the food or combinations thereof.

Also, while the examples above have been described with reference to determining a specific food type, it is understood that the determination of a food type may include determining that the food belongs to a specific category of food. For example, based on the first and second inputs, the system may determine that the consumed food is a food containing a high amount of carbohydrates and categorize the food as being a “high carbohydrate” type of food. In some examples, the system may not attempt to distinguish between certain types of food, especially where the distinction between food types may yield negligible differences. For example, it may not be significant for the system to distinguish between rice and pastas that have similar nutritional characteristics. Likewise, distinguishing between different types of poultry may not yield significant nutritional differences. As such, the system may broadly determine the food type without identifying the specific scientific name of the food, the food's brand or other identifiers. However, in some examples, the system may make such distinctions and narrowly identify each food type.

### INDUSTRIAL APPLICABILITY

In general, the invention disclosed herein may provide the user with a convenient system for counting the number of calories that the user consumes within a time period. This may be accomplished with a camera incorporated into an wearable device that can be used to determine the amount of food that the user is consuming as well as identify the type of food that the user in consuming. By combining the volume of food with the type of food, the system can ascertain through look-up libraries the number of calories that the user has consumed. In some examples, other nutritional information can also be displayed to the user.

The user may set a goal to consume more or less than a specific number of calories. Such a goal may be inputted into the system through any appropriate input mechanism. As the user consumes food, status notifications may be sent to the user on a regular basis or in response to exceeding the goals.

The food volume may be determined based on the area in the image dedicated to the food. For example, the tracking system may divide the image into regions that correspond to known volume amounts. Such regions may include a predetermined number of pixels, include a fraction of the screen, include another mechanism for defining the regions or combinations thereof. In other examples, the regions may be associated with dimensions of the food, and based on those dimensions, the tracking system can determine the food volume.

The food type may be determined based on the colors of the food or other visual characteristics perceivable in the images. In one example, an optical analyzer can separate the light wavelengths captured in the image to determine the food. A library may associate specific patterns and/or clusters of wavelengths with specific types of food. In those situations where the wavelength clusters and/or other characteristics match the wavelength characteristics in the library, the tracking system may make the conclusion that the associated food in the library is the food in the picture.

The camera may be positioned with eye wear, adhesives, hats, jewelry, clothing, head gear, other wearable devices or combinations thereof. The calorie number, the volume of food, the type of food, other nutritional data or combinations thereof may be sent to a remote database for storage. Such remote storage may be accessible to the user over a network, such as the internet. The user may access the records of his or her eating history, determine eating patterns and habits and make adjustments. In some situations, this nutritional information may be stored in a database or be accessible to a user profile of an exercise program, such as can be found at www.ifit.com as described above. In some examples, this nutritional information may be made public at the user's request or be made viewable to certain people. Such individuals may give the user advice about improving eating habits. In other examples, the user may compete with others to have lower amounts of calories within a time period or to achieve a different type of nutritional goal.

What is claimed is:

1. A wearable device, comprising:
a camera oriented in a field of view of a user when the wearable device is worn by the user;
the camera being in communication with a processor and memory, the memory comprising programmed instructions executable by the processor to:
detect food in the field of view;
identify a type of the food within a user's field of view; and
generate a calorie value associated with the food.

2. The wearable device of claim 1, wherein the programmed instructions are further executable by the processor to determine a volume of the food.

3. The wearable device of claim 1, wherein the processor is in communication with a food library that associates a food type with calories per volume.

4. The wearable device of claim 1, wherein the camera comprises an optical separator to separate wavelengths of light.

5. The wearable device of claim 1, wherein a determination of a food type is based at least in part on at least one optical wavelength characteristic of an image taken with the camera.

6. The wearable device of claim 1, wherein the programmed instructions are further executable by the processor to determine a volume of the food based on different views of the food from different angles.

7. The wearable device of claim 1, wherein the programmed instructions are further executable by the processor to determine whether the user is bringing food towards a mouth of the user.

8. The wearable device of claim 7, wherein the programmed instructions are further executable by the processor to cause the camera to automatically capture an image of the food if the user is determined to bring the food towards the mouth.

9. The wearable device of claim 1, wherein the programmed instructions are further executable by the processor to communicate the calorie value to the user.

10. The wearable device of claim 1, wherein the programmed instructions are further executable by the processor to notify the user that the calorie value in combination with previously consumed calories exceeds a calorie threshold.

11. The wearable device of claim 1, wherein the programmed instructions are further executable by the processor to determine whether the user consumed the food.

12. The wearable device of claim 11, wherein the programmed instructions are further executable by the processor to send the calorie value to storage if the food is determined to have been consumed by the user.

13. A wearable device, comprising:
a camera oriented in a field of view of a user when the wearable device is worn by the user;
the camera being in communication with a processor and memory, the memory comprising programmed instructions executable by the processor to:
determine whether the user is bringing food towards a mouth of the user;
cause the camera to automatically capture an image of the food if the user is determined to bring the food towards the mouth;
identify a type of food within a user's field of view based at least in part on the image;
determine a volume of the food;
generate a calorie value associated with the food; and
communicate the calorie value to the user.

14. The wearable device of claim 13, wherein the processor is in communication with a food library that associates a food type with calories per volume.

15. The wearable device of claim 13, wherein the programmed instructions are further executable by the processor to determine a volume of the food based on different views of the food from different angles.

16. The wearable device of claim 13, wherein the programmed instructions are further executable by the processor to notify the user that the calorie value in combination with previously consumed calories exceeds a calorie threshold.

17. The wearable device of claim 13, wherein the programmed instructions are further executable by the processor to determine whether the user consumed the food.

18. The wearable device of claim 17, wherein the programmed instructions are further executable by the processor to send the calorie value to storage if the food is determined to have been consumed by the user.

19. The wearable device of claim 17, wherein the programmed instructions are further executable by the processor to determine a food type base at least in part at least one optical wavelength characteristic of the image.

20. A wearable device, comprising:
a camera oriented in a field of view of a user when the wearable device is worn by the user;
the camera being in communication with a processor and memory, the memory comprising programmed instructions executable by the processor to:
determine whether the user is bringing food towards a a mouth of the user;
cause the camera to automatically capture an image of the food if the user is determined to bring the food towards the mouth;
identify a type of food within a user's field of view based at least in part on the image;
determine a volume of the food based on different views of the food from different angles;
determine a calorie value associated with the food;
communicate the calorie value to the user;
determine whether the user consumed the food; and
send the calorie value to storage if the food is determined to have been consumed by the user;
wherein the processor is in communication with a food library that associates a food type with calories per volume.
